(19) United States
(12) Patent Application Publication
(10) Pub. No.: US 2013/0018823 A1
(43) Pub. Date: Jan. 17, 2013

(54) Detecting undesirable content on a social network

(71) Applicant: Syed Ghouse Masood, Kuala Lumpur (MY)

(72) Inventor: Syed Ghouse Masood, Kuala Lumpur (MY)

(73) Assignee: F-Secure Corporation

(21) Appl. No.: 13/135,808

(22) Filed: Jul. 15, 2011

(51) Int. Cl. G06F 15/18; G06N 5/02

(52) U.S. Cl. 706/12; 706/54

(57) ABSTRACT

A method of detecting undesirable content on a social networking website. The method includes retrieving or accessing a post from a user's social networking page, identifying the content of a pre-defined set of features of the post, comparing the identified feature content with a database of known undesirable post feature content, and using the results of the comparison to determine whether the post is undesirable.

### TECHNICAL FIELD

The present invention relates to a method of detecting undesirable content (for example malicious content and/or “spam”) on a social network website. In particular the present invention relates to a method feature content analysis to detect undesirable posts.

### BACKGROUND

Online social interaction between individuals enabled by social networking websites is one of the most important developments of this decade. Almost everyone who has access to the internet is a member of an online social network in some way. The most well-known social network website, Facebook™, recently announced that they have 750 million active users. It is, therefore, not surprising that social networking sites have become an attractive target for malicious third parties, for example spammers, who desire to direct users to content “owned” by those malicious third parties. Such content might be malicious, e.g. a webpage containing malware and exploits, a fake bank website, or may be inappropriate or simply annoying.

Considering Facebook, for example, each user has their own Facebook page on which they can provide “posts”. These posts can comprise, for example, written status updates/messages, shared photos, links, videos etc. The area of the user's Facebook page which contains these posts is known as their “wall”. The user has a “friends list” which comprises a list of the people with whom they have chosen to interact with on the site. There are a number of ways in which posts can appear on a user's wall, and FIG. 1 shows a representation of all the potential inputs to a Facebook user's profile wall. FIG. 1 also shows the types of media that are permitted as posts, and the risks that they can lead to. For example, a message, photo or video posted to a user's wall could contain inappropriate content. A link presents perhaps the highest risk as it could lead to a so-called “drive-by” download resulting in the infection of a user's computer by malware.

Each Facebook user will also have a “news feed” which shows an amalgamation of recent posts from other users on their friends list, as well as other information such as profile changes, upcoming events, birthdays etc. Generally, friends of the user are happy to click a link in one of the user's posts (as seen on the user's wall or on the friend's news feed) as the link appears to have originated from someone they know or trust. Such feeds provide another route to access an attacker's content.

Facebook does provide privacy settings which limit the number of potential inputs to a user's profile wall, and also limit the potential audience that is able to view the posts on the user's profile wall, and receive the post in their news feed. For instance, a user may only allow friends and friends-of-friends to post on his or her wall, blocking the ability to post from everyone else and applications. The user may also limit who is able to see his or her posts (either on their wall or through a news feed) to just friends, for example. Unfortunately, these privacy settings do not provide a comprehensive alternative to proper security mechanisms. A user may not wish to set his or her privacy settings to a high level, for example, if he or she wants anyone to be able to view and post on his or her wall. Even if high privacy settings are in place, they have no effect if the profile owner's, or his/her friend's, account is compromised, or if the user is tricked into granting access privileges to a Facebook application. When a user's profile is used to display posts that they have not authorised, or have not intended to authorise, this is known as an “abuse-of-trust” attack.

In a typical abuse-of-trust attack, a user sees a post in their news feed that appears to come from a person in their friends list. The post will typically contain a link to an external website. The user, assuming that the post has been submitted by a person they trust and that the link is safe, clicks the link and visits the website. On doing this, a similar malicious/spam post is generated on the user's own wall, which is then shared with the people in his or her own friends list who might fall for the same attack. These malicious/spam posts that are automatically generated on clicking the link are how the attack propagates.

Apart from abuse-of-trust attacks, there are a large number of other known ways in which undesirable posts can be generated on a user's wall (and of course other attack mechanisms may be discovered in the future). One such known alternative is when a user's machine is infected by malware. This type of malware is able to detect when the user is accessing Facebook, and generates an undesirable post on their wall as a means of spreading.

### SUMMARY

It is an object of the present invention to stop or reduce the spread of undesirable posts such as malicious posts or spam on a social networking website by providing a method of automatically detecting said undesirable posts.

According to a first aspect of the invention there is provided a method of detecting undesirable content on a social networking website. The method comprises retrieving or accessing a post from a user's social networking page, identifying the content of a pre-defined set of features of the post, comparing the identified feature content with a database of known undesirable post feature content, and using the results of the comparison to determine whether the post is undesirable.

The method may comprise, for content of a given feature, generating a “fingerprint” representative of the content (this could for example be a hash value). The fingerprints generated for the or each feature are then compared against fingerprints maintained within the database. It is also possible that content from multiple features, or indeed multiple corresponding fingerprints, could be combined into a single, super-fingerprint, to simplify the database searching operation.

Embodiments of the present invention may provide a way for a user of a social networking website to more easily detect and, if desired, subsequently remove any undesirable posts such as spam or malicious posts.

The pre-defined set of features may comprise at least one of a username, a message, a link, a link title, a picture thumbnail, the URL to the picture thumbnail, and a link description.

The method may further comprise alerting the user when a post is determined to be undesirable, and/or automatically deleting a post that is determined to be undesirable from the user's social networking page. The method may also comprise alerting the originator of the undesirable post.

The method may be carried out by a security application installed on the user's terminal or may be carried out on a server owned by a security service provider.

The database of known undesirable feature content may be either locally stored on a client-terminal or centrally stored in a central server.

According to a second aspect of the invention there is provided a method of creating an entry in a known undesirable post signature database, the method comprising identifying a suspicious post on social networking site and determining whether the suspicious post is an undesirable post. Then, if the post is determined to be undesirable, identifying a set of pre-determined features of the undesirable post to be used in the signature, using the content of each pre-determined feature as a value within the signature, creating a signature by compiling the set of pre-determined features and corresponding value, and adding the signature to the database of signatures for known undesirable posts.

The set of pre-determined features identified for use in the signature may comprise one or more of a username, a message, a link, a link title, a picture thumbnail, the URL to the picture thumbnail, and a link description.

The undesirable post may be one of a number of similar undesirable posts that are part of the same attack and which are grouped together to create a single signature.

The values for one or more of the pre-determined set of features in the number of undesirable posts may be patterns.

A pattern may be created using a list of expressions regularly found in a pre-determined feature within the group of similar undesirable posts.

### BRIEF DESCRIPTION OF THE DRAWINGS

FIG. 1 shows a representation of the inputs, post-types and associated risks for a Facebook profile wall;

FIG. 2 shows an example of an undesirable post found on a Facebook user's news feed;

FIG. 3 is a flow diagram illustrating a method for creating an entry in the signature database for an undesirable post according to an embodiment of the invention; and

FIG. 4 is a flow diagram illustrating a method of detecting and dealing with undesirable posts in a social network according to an embodiment of the present invention.

### DETAILED DESCRIPTION

As previously discussed, social networking sites are very popular and often have a large number of subscribers, thus making them an attractive target for malicious third parties. A common annoyance encountered by users of social networking sites is that of undesired posts such as spam or malicious posts. A method will now be disclosed that provides a means to automatically detect said undesirable posts.

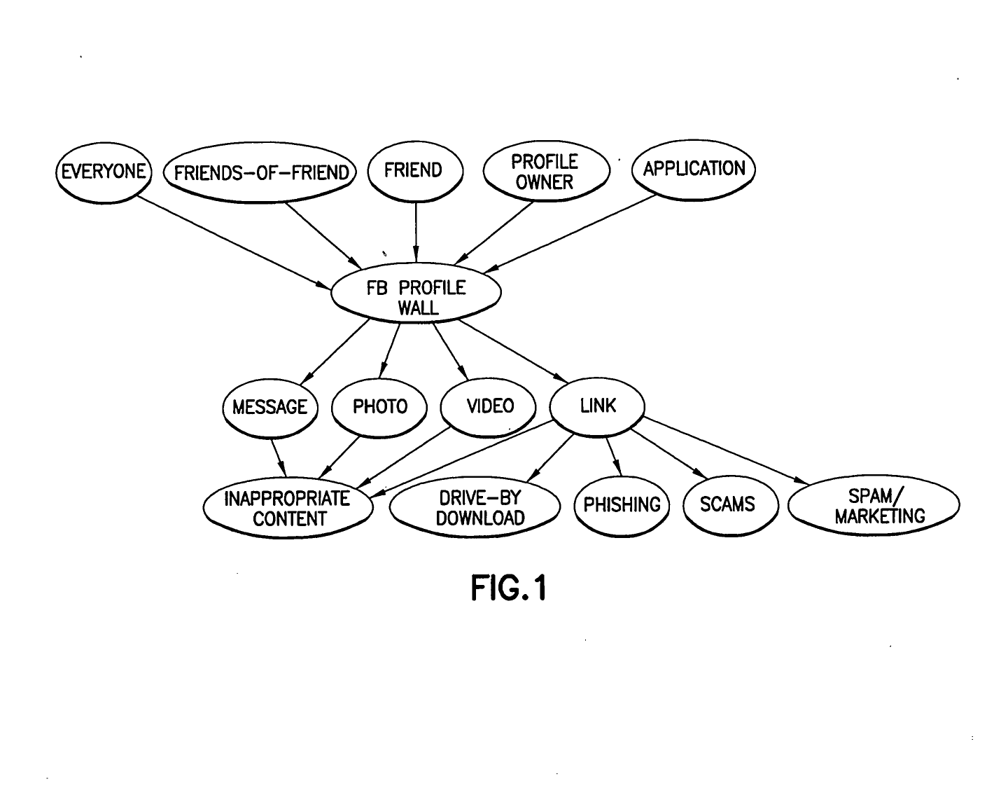

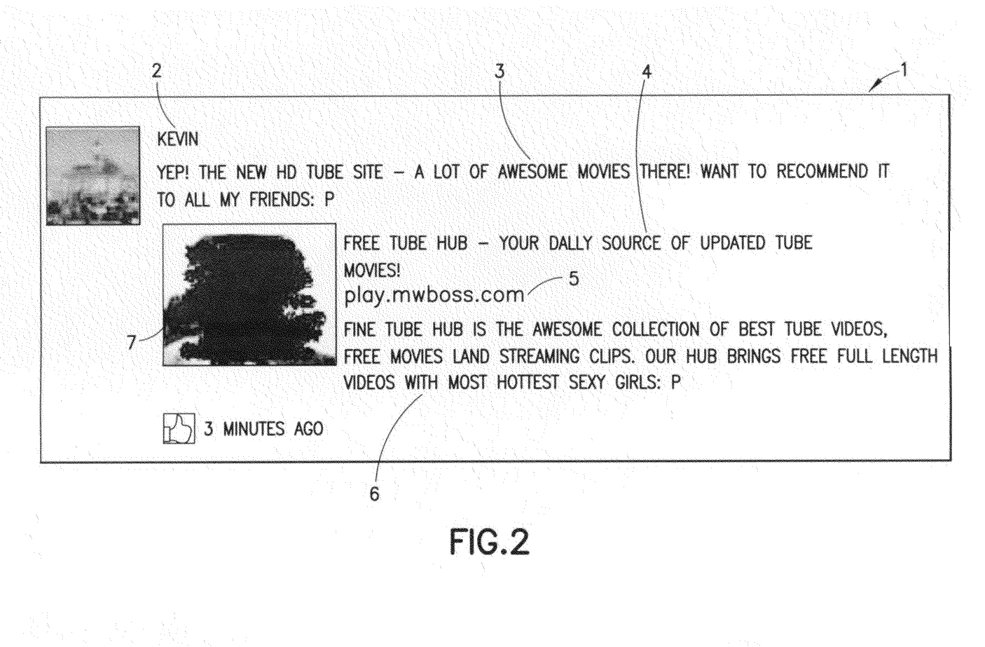

FIG. 2 shows a screenshot of an undesirable post 1 on the social networking website Facebook™. Posts on any social networking site generally have a fixed structure consisting of a number of elements, or “features”. The features that can be seen in FIG. 1 are:
the username 2 of the person sharing the post (either voluntarily or involuntarily)
a message 3 “from” the person sharing the post
a link/link title 4
the link domain name 5
a description of the link 6
a thumbnail picture 7

The proposed method takes advantage of this fixed structure of pre-defined features and their content and uses a “signature” for undesirable posts in much the same way as a computer antivirus program uses signatures in order to detect malicious software. Typically, these signatures will be stored in a database on a central server maintained by a provider of a security application.

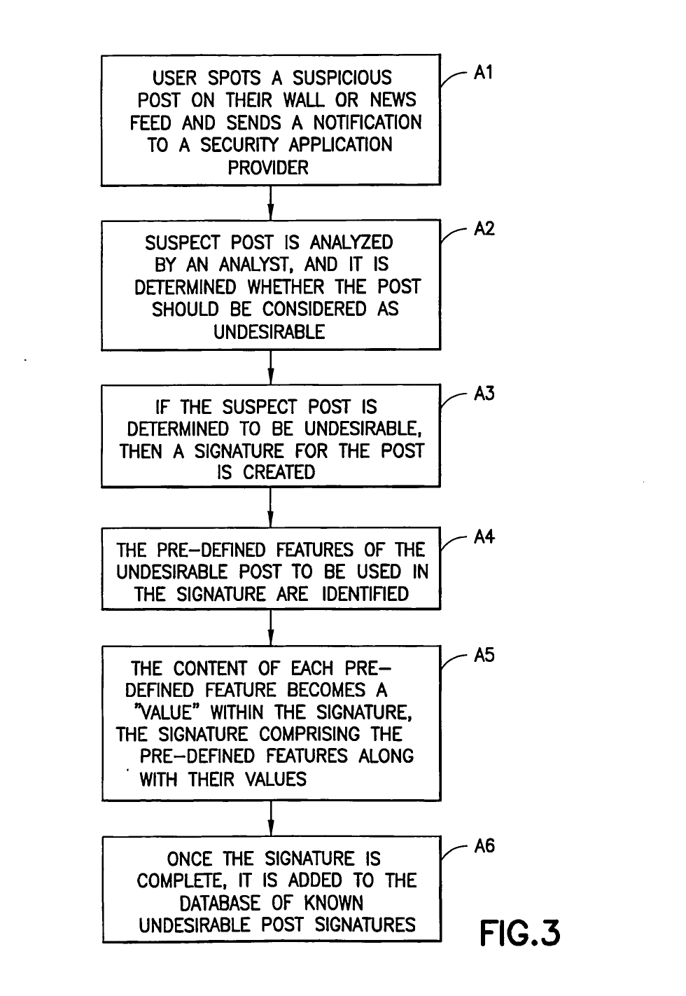

FIG. 3 is a flow diagram illustrating a method for creating an entry in the signature database for an undesirable post. The steps of the method are:
A1. A social network user spots a suspicious post on their wall or news feed and sends a notification to a security application provider.
A2. The suspect post is analysed by an analyst at the security application provider, and it is determined whether the post should be considered as undesirable (e.g. it is malicious or spam).
A3. If the suspect post is determined to be undesirable, then a signature for the post is created.
A4. The pre-defined features of the post that are to be used in the signature are identified.
A5. The content of each pre-defined feature becomes a “value” within the signature, the signature comprising the pre-defined features along with their values.
A6. Once the signature is complete, it is added to a database of known undesirable post signatures (“signature database”).

In step A1, the social network user alerts the security application provider to a suspicious post. The user may have already fallen for the abuse-of-trust attack, or may just suspect that the post could be undesirable. The notification can be sent to the security application provider in a number of ways. For example, if the user is a subscriber to the security application, the application may provide an alert button or link associated with each post that the user can click which will send details of the suspect post to the security application provider. Alternatively, a link to the page containing the suspect post may be sent by email. Additionally, the security application provider may learn of a new attack by other means, without having to be notified by users. For example a team of analysts may monitor the social networking websites, or honeypot-like automated systems can be used to discover suspicious posts.

In step A2, an analyst at the security application provider analyses the suspect post. The analysis can be carried out, for example, by following the link within a controlled environment. If the link leads to malicious or spam content, for example an unsafe site or a malicious download, then the analyst can flag the post as being an undesirable post.

In step A3, once the suspect post has been determined to be undesirable, the analyst can create a signature for the undesirable post.

Steps A4 and A5 describe how the signature is created. First the analyst determines which of the pre-determined features of the undesirable post will be most suitable for use in the signature for the undesirable post. For example the analyst may choose only the message, link title, link description and thumbnail URL. Once this set of pre-determined features has been chosen, the signature is created using part or all of the content of each pre-determined feature as a “value” that can be compared with the content of other posts to be scanned in the future. For example the signature for an undesirable post can be a logical expression that searches for matches between the content of a feature of a post being scanned and value of the corresponding feature in the undesirable post for which it is a signature. For example:

IF
(‘message’ MATCHES “valueA”) AND (‘link_title’ MATCHES
“valueB”) AND (‘link_description’ MATCHES “valueC”) AND
(‘thumbnail_URL’ MATCHES “valueD”)
THEN
Post is undesirable.

If the undesirable post looks similar to other undesirable posts that have already been detected, then the similar undesirable posts can be grouped together and the pre-determined features and values for all the similar undesirable posts are used to form a single, common signature. For sets of similar undesirable posts, the values of the corresponding pre-determined features in each post may be identical or alternatively may form a pattern. In this case, instead of a value being used in the signature, a pattern is used in its place. For example, a signature for a similar group of undesirable posts may be:

IF
(‘message’ MATCHES “patternX”) AND (‘link_title’ MATCHES
“valueB”) AND (‘link_description’ MATCHES “patternY”) AND
(‘thumbnail_URL’ MATCHES (“valueD” OR “valueE”))
THEN
Post is undesirable.

In the above example, the message and link description both have patterns (patternX and patternY respectively) that satisfy the logic, and the thumbnail URL can be one of two values (valueD and valueE). A pattern may be created by using “regular expressions” that are frequently found in the content of that pre-determined feature within the group of similar undesirable posts. For example a feature could be found to match patternX if it contained one or more of a number of expressions such as “full length videos”, “free movies” or “hottest sexy girls”.

Finally in Step A6, the signature is added to the signature database. This database will typically be stored on a central server maintained by the provider of the security application. The signature database can then be used by a security application to detect undesirable posts on a user's social network page.

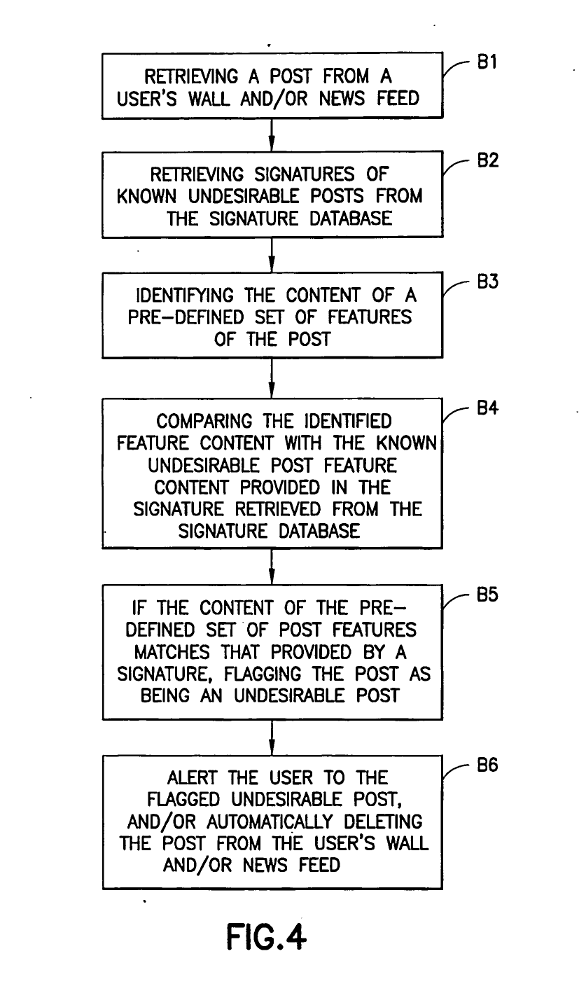

FIG. 4 is a flow diagram illustrating a method of detecting and dealing with undesirable posts in a social network. The steps of the method are:
B1. Retrieving a post from a user's wall and/or news feed.
B2. Retrieving signatures of known undesirable posts from the signature database.
B3. Identifying the content of a pre-defined set of features of the post;
B4. Comparing the identified feature content with the known undesirable post feature content values provided in the signatures retrieved from the signature database.
B5. If the content of the pre-defined set of post features matches the content values provided within a signature, flagging the post as being an undesirable post.
B6. If a post is flagged as being undesirable, alerting the user to the flagged undesirable post, and/or automatically deleting the post from the user's wall and/or news feed.

The method described in Steps B1 to B6 will typically be carried out by a security application, for example a Facebook Security Application, that is installed by the user on his or her client terminal in order to protect their social network account. The user will open the security application and select an option to scan his or her wall and/or news feed posts. Alternatively, the security application may run in the background and automatically detect when new posts appear on the user's social network webpage and trigger a scan on the new posts as they appear.

A further alternative may be that the application is run from a server that is owned by the security service provider. In this case, the user will have to provide their log in details for the social networking website so that the service provider is able to perform the scan at their server, or if the application has been implemented as a Facebook Application, the user would need to add the application to his or her profile and grant it the required permissions.

In step B1, a post is retrieved from the user's wall or news feed. Alternatively, the security application may simply access the user's wall or news feed, without needing to retrieve the post. Many social networks now provide public APIs to application developers that allow permissions to be granted to applications such as the security application described herein. For example, Facebook Connect allows a user to grant permission to an application such that it can pick up data such as the user's wall and/or news feed. This will allow the security application the permission it needs in order to carry out the scan.

In step B2, the signatures of known undesirable posts are retrieved from the signature database. The database can be stored locally on a client terminal or stored remotely on a central server. If the database is stored remotely, the retrieved signatures may be locally stored in a local cache where the application is installed.

In step B3, the content of a pre-defined set of features of the post is identified. This pre-defined set of features will match with the pre-defined set of features that are used in the creation of the undesirable post signatures.

In step B4, the content identified in step B3 is compared with the content values provided within the signatures retrieved from the signature database. The content for one or more of the pre-defined features in the post may match a value or pattern that has been specified for that pre-defined feature in the signature. If the content for all of the pre-defined features matches the values and/or patterns of the pre-determined features in the signature, then the post is flagged as being undesirable in step B5. Alternatively, a post may be flagged as undesirable if the content of a high enough proportion of pre-defined features match that found in a signature.

Once the post has been flagged, the application can be configured to carry out one or more actions in order that the undesirable post is dealt with appropriately. For example, in Step B6 the user is simply alerted that the post has been found to be undesirable. Alternatively, or in addition to user alert, the post can be deleted by the security application. The actions carried out by the security application may be configured by the user in the application's preferences.

If the undesirable post is detected on the user's news feed, and the post has been submitted by one of the people on the user's friends list, the application may not have sufficient access privileges to delete the post. In this instance, the user will be alerted to the undesirable post and may also be given the option to send a message to the person from whom the post originated, alerting them to the fact that an undesirable post has been submitted from their account.

The security application can be installed and used in a number of ways. For example the application may be software installed on a client terminal belonging to a user, with the application being able to load up an instance of the social network to be scanned within the application. Alternatively the application may be run on a server owned by the security service provider and provided to the user as a web application that can be controlled within an internet browser environment. In a further alternative embodiment, the application may be installed as an internet browser plug-in.

The examples provided above describe the method in the context of a user on the Facebook social network site. However, it will be understood that the method can be implemented within a number of online social network environments, for example Twitter™, Google+™, and also any website that allows users to post comments such as YouTube™ or personal blogging websites.

It will be appreciated by the person of skill in the art that various modifications may be made to the above described embodiments without departing from the scope of the present invention.

1. A method of detecting undesirable content on a social networking website, the method comprising:
retrieving or accessing a post from a user's social networking page;
identifying the content of a pre-defined set of features of the post;
comparing the identified feature content with a database of known undesirable post feature content; and
using the results of the comparison to determine whether the post is undesirable.

2. A method as claimed in claim 1, wherein the pre-defined set of features comprises at least one of a username, a message, a link, a link title, a picture thumbnail, the URL to the picture thumbnail, and a link description.

3. A method as claimed in claim 1, wherein the method further comprises alerting the user when a post is determined to be undesirable.

4. A method as claimed in claim 1, wherein the method further comprises automatically deleting a post that is determined to be undesirable from the user's social networking page.

5. A method as claimed in claim 1, wherein the method comprises alerting the originator of the undesirable post.

6. A method as claimed in claim 1, wherein the method is carried out by a security application installed on the user's terminal.

7. A method as claimed in claim 1, wherein the method is carried out on a server owned by a security service provider.

8. A method as claimed in claim 1, wherein the database of known undesirable feature content is either locally stored on a client-terminal or centrally stored in a central server.

9. A method of creating an entry in a known undesirable post signature database, the method comprising:
identifying a suspicious post on social networking site;
determining whether the suspicious post is an undesirable post;
if the post is determined to be undesirable, identifying a set of pre-determined features of the undesirable post to be used in the signature;
using the content of each pre-determined feature as a value within the signature;
creating a signature by compiling the set of pre-determined features and corresponding value; and
adding the signature to the database of signatures for known undesirable posts.

10. A method as claimed in claim 9, wherein the set of pre-determined features identified for use in the signature comprise one or more of a username, a message, a link, a link title, a picture thumbnail, the URL to the picture thumbnail, and a link description.

11. A method as claimed in claim 9, wherein the undesirable post is one of a number of similar undesirable posts that are part of the same attack and which are grouped together to create a single signature.

12. A method as claimed in claim 11, wherein the values for one or more of the pre-determined set of features in the number of undesirable posts are patterns.

13. A method as claimed in claim 12, wherein a pattern is created using a list of expressions regularly found in a pre-determined feature within the group of similar undesirable posts.
